(19) United States
(12) Patent Application Publication
(10) Pub. No.: US 2022/0258536 A1
(43) Pub. Date: Aug. 18, 2022

(54) TIRE

(71) Applicant: The Yokohama Rubber Co., LTD., Tokyo (JP)

(72) Inventors: Kenta HOMMA, Kanagawa (JP); Tatsuro SHINZAWA, Kanagawa (JP); Atsuhito NAKANO, Kanagawa (JP)

(21) Appl. No.: 17/595,540

(22) PCT Filed: May 12, 2020
(86) PCT No.: PCT/JP2020/018952

§ 371 Date: Nov. 18, 2021

(30) Foreign Application Priority Data
May 28, 2019 (JP) 2019-099319

(51) Int. Cl. B60C 9/00; B60C 11/03

(52) U.S. Cl. CPC B60C 9/0042; B60C 2009/0458; B60C 11/0304

(57) ABSTRACT

A carcass layer of a run-flat tire includes a carcass cord formed by twisting together organic fibers, wherein a breaking elongation Eb of the carcass cord, an average thickness Gs of a sidewall between a tire maximum width position of the sidewall and a position separated from the tire maximum width position to the outer side in a tire radial direction by a length equivalent to 15% of a tire cross-section height, and an average thickness Gsh in a tread between a shoulder position where a straight line orthogonal to the carcass layer and passing through a maximum width belt layer maximum width position intersects a surface of the tread and a position separated from the shoulder position toward the inner side in the tire width direction by a length equivalent to 15% of a maximum width belt layer maximum width satisfy: Eb≥20%; Gsh≥10 mm; Gs≥9 mm; and 60%≥Eb·Gsh/Gs≥18%.

### TECHNICAL FIELD

The present technology relates to a tire.

### BACKGROUND ART

Conventionally, a run-flat tire of the side reinforced type in which a sidewall portion is reinforced with a side reinforcing rubber layer has been known as a run-flat tire that makes it possible to safely travel a certain distance even when an internal pressure thereof is reduced due to a puncture or the like.

In such a tire, it is desired that durability be ensured so as to be able to travel a certain distance during run-flat traveling and that rim disengagement not occur easily.

For example, in run-flat tires of the side reinforced type, a side reinforced run-flat tire with improved rim disengagement has been proposed (see Japan Unexamined Patent Publication No. 2015-205583). In a side reinforced run-flat tire:

(1) A tire cross-section height is 115 mm or more;

(2) L>0.14×SH (L is an overlap width (one side) in a tire axial direction of an inclined belt layer having the greatest width in the tire axial direction (maximum width inclined belt layer) and a side reinforcing rubber layer, and SH is a tire cross-section height);

(3) GD/Ga≥0.3 (Gd is a thickness of the side reinforcing rubber layer at a position, on an inner side in the tire axial direction, 14% of the tire cross-section height from an edge in the tire axial direction of the maximum width inclined belt layer, and Ga is a thickness of the side reinforcing rubber layer at the widest position of a carcass).

In the side reinforced run-flat tire described above, when focusing on a region near a tread edge where large bending occurs, which causes the occurrence of buckling, by adjusting the thickness and length at a predetermined position, the bending rigidity of the region can be sufficiently improved, buckling of a tire sidewall portion can be suppressed, and rim disengagement can be improved.

However, in the side reinforced run-flat tire, the thickness of the side reinforcing rubber layer is thick and the weight increases so as to ensure durability to be able to run a predetermined distance in a run-flat state. In addition, because vertical spring characteristics of the tire are also high, the tire is subjected to a large impact during traveling, and consequently so-called shock bursts are likely to occur where a carcass layer breaks, that is, shock burst resistance is easily reduced.

### SUMMARY

The present disclosure provides a tire reinforced with a side reinforcing rubber layer (side reinforced run-flat tire) that can maintain at least either one of run-flat durability and shock burst resistance while improving the other.

A tire according to one aspect of the present disclosure includes a tread portion extending in a tire circumferential direction and having an annular shape, a pair of sidewall portions including side rubbers disposed on both sides of the tread portion, a pair of bead portions disposed on an inner side of the sidewall portions in a tire radial direction, at least one carcass layer mounted between the pair of bead portions, a side rubber reinforcing layer that extends in the tire radial direction along an inner surface on an inner surface side of the carcass layer of the sidewall portions and that reinforces the side rubbers, and a plurality of belt layers arranged on an outer side of the carcass layer in the tread portion in the tire radial direction.

The carcass layer is composed of a carcass cord formed of organic fiber cords formed by twisting together a filament bundle of organic fibers, and when a breaking elongation of the carcass cord is taken as Eb, an average thickness of the sidewall portions between a tire maximum width position of the sidewall portions in the tire radial direction and a position separated from the tire maximum width position to the outer side in the tire radial direction by a length equivalent to 15% of a tire cross-section height is taken as Gs, and an average thickness in the tread portion between a shoulder position where a straight line orthogonal to the carcass layer and passing through a maximum width position of a maximum width belt layer of the belt layer intersects a surface of the tread portion, and a position separated from the shoulder position toward an inner side in a tire width direction by a length equivalent to 15% of a maximum belt width of the maximum width belt layer is taken as Gsh, Eb, Gs, and Gsh satisfy the following:

(1) Eb≥20%;

(2) Gsh≥10 mm;

(3) Gs≥9 mm; and

(4) 60%≥Eb·Gsh/Gs≥18%.

It is preferred that the bead portions each include a bead core extending in an annular shape in the tire circumferential direction, and a bead filler rubber extending from the bead core toward the outer side in the tire radial direction, and that a length of a maximum height position of the bead filler rubber along the tire radial direction from a position at an innermost portion of the bead portion in the tire radial direction be 40 to 60% of the tire cross-section height.

It is preferred that an elongation of the carcass cord when subjected to a load of 1.5 cN/dtex in the sidewall portions be 5.0% or more.

It is preferred that an elongation of the carcass cord when subjected to a load of 1.5 cN/dtex in the sidewall portions be 5.0% to 6.5%.

It is preferred that the breaking elongation Eb of the carcass cord be 22% to 24%.

It is preferred that the organic fibers constituting the carcass cord be polyethylene terephthalate fibers.

It is preferred that a fineness based on corrected mass after dip processing of the carcass cord be 4000 to 8000 dtex.

It is preferred that a twist coefficient K expressed by the following equation after dip processing of the carcass cord be 2000 to 2500:

K=T×D½,

(where T is an upper twist count (times/10 cm) of the carcass cord and D is a total fineness (dtex) of the carcass cord).

The tire described above can maintain at least either one of run-flat durability and shock burst resistance while improving the other.

### BRIEF DESCRIPTION OF DRAWINGS

FIG. 1 is a tire cross-sectional view illustrating a tire according to an embodiment.

FIG. 2 is a diagram illustrating a tread pattern of tires manufactured in experiment examples.

### DETAILED DESCRIPTION

Hereinafter, a tire of the present disclosure will be described in detail.

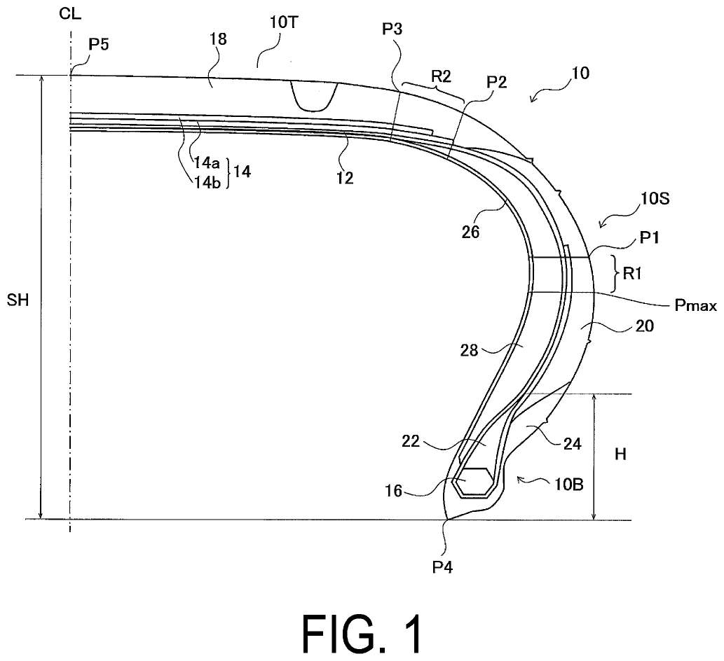

“Tire circumferential direction” described below refers to the direction in which a tread surface rotates when a tire rotates about a tire rotation axis, “tire radial direction” refers to the direction that extends radially so as to be orthogonal to the tire rotation axis, and “outer side in the tire radial direction” refers to the side away from the tire rotation axis. “Tire width direction” refers to the direction parallel to a tire rotation axis direction, and “outer side in the tire width direction” refers to both sides away from a tire centerline of the tire. The tire circumferential direction is, for example, a direction perpendicular to the paper surface illustrated in FIG. 1.

“Inner surface in the tire” refers to the surface facing a tire cavity region that becomes filled with air when the tire is mounted on a rim and filled with air.

Dimensions of the tire described hereinafter indicate the dimensions obtained when the tire is mounted on a regular rim and inflated to a regular internal pressure. “Regular rim” refers to a “standard rim” defined by the Japan Automobile Tyre Manufacturers Association (JATMA) if the tire complies with JATMA standard, a “Design rim” defined by the Tire and Rim Association (TRA) if the tire complies with TRA standard, or a “Measuring Rim” defined by the European Tyre and Rim Technical Organisation (ETRTO) if the tire complies with ETRTO standard. Furthermore, “regular internal pressure” refers to a “maximum air pressure” defined by JATMA, the maximum value described in “TIRE LOAD LIMITS AT VARIOUS COLD INFLATION PRESSURES” defined by TRA, or “INFLATION PRESSURES” defined by ETRTO, depending on the standard with which the tire complies.

Additionally, the tire according to the present disclosure may be a tire filled with an inert gas such as nitrogen, argon, or helium in addition to a pneumatic tire that is filled with air. The tire according to the present disclosure is a run-flat tire that is capable of traveling without being filled with air or an inert gas.

FIG. 1 is a tire cross-sectional view of a tire 10 according to an embodiment. The tire 10 includes a tread portion 10T that extends in the tire circumferential direction and has an annular shape and that has a tread pattern, a pair of sidewall portions 10S including side rubbers 20 that are respectively disposed on both sides of the tread portion 10T, and a pair of bead portions 10B each disposed on an inner side of the sidewall portions 10S in the tire radial direction.

The tire 10 includes a carcass layer 12, a belt layer 14, and bead cores 16 as framework members or layers of framework members and mainly includes a tread rubber 18, the side rubbers 20, bead filler rubbers 22, rim cushion rubbers 24, an innerliner rubber 26, and a side reinforcing rubber layer 28, around these framework members.

The carcass layer 12 is provided between the pair of bead portions 10B. Specifically, the carcass layer 12 forms a toroidal shape by being wound between the pair of annular bead cores 16. The carcass layer 12 is composed of at least one layer of a carcass ply member formed by covering a carcass cord with rubber, the carcass cord being formed of organic fiber cords formed by twisting together a filament bundle of organic fibers. The carcass ply member is wound around the bead cores 16 and extends to the outer side in the tire radial direction. The belt layer 14 is provided on an outer side of the carcass layer 12 in the tire radial direction, the belt layer 14 being composed of two belt members 14a and 14b. The belt members 14a and 14b are each a member made of a steel cord that is coated with rubber and disposed inclined at a predetermined angle of, for example, 20 to 30 degrees with respect to the tire circumferential direction. A width of the lower layer belt member 14a in the tire width direction is greater than that of the upper layer belt member 14b. The directions of inclination of the steel cords of the belt members 14a and 14b are opposite to each other with respect to the tire circumferential direction in which a tire equatorial plane CL extends. Accordingly, the belt members 14a and 14b are crossing layers serving to suppress expansion of the carcass layer 12 caused by the pressure of the filled air.

The tread rubber 18 is provided on the outer side of the belt layer 14 in the tire radial direction. Both ends of the tread rubber 18 are connected to the side rubbers 20 to form the sidewall portions 10S. The rim cushion rubbers 24 are provided at the ends of the side rubbers 20 on the inner side in the tire radial direction and come into contact with the rim on which the tire 10 is mounted. The bead filler rubbers 22 are provided on the outer side of the bead cores 16 in the tire radial direction so as to be interposed between a portion of the carcass layer 12 that is not yet wound around the bead cores 16 and a portion of the carcass layer 12 that is wound around the bead cores 16. The innerliner rubber 26 is provided on the inner surface of the tire 10 facing a tire cavity region that is filled with air and is surrounded by the tire 10 and the rim.

The side reinforcing rubber layer 28 is a member having a crescent-shaped cross-sectional shape, extending in the tire radial direction along the inner surface on the side of the inner surface of the carcass layer 12 of the sidewall portion 10S, and reinforcing the side rubbers 20. The side reinforcing rubber layer 28 is provided so as to be sandwiched between the carcass layer 12 and the innerliner rubber 26 from the shoulder side of the tread portion 10T to the bead portion 10B via the sidewall portions 10S, on the tire cavity region side. A high-modulus, low-heat-generating rubber material is used in the side reinforcing rubber layer 28 in order to prevent the sidewall portions 10S from bending beyond necessity while suppressing heat buildup associated with deformation of the tire during run-flat traveling. In other words, the tire 10 is a run-flat tire in which the sidewall portions 10S are reinforced by the side reinforcing rubber layer 28.

In addition, although not shown in FIG. 1, the tire 10 is provided with a belt cover layer that covers the belt layer 14 from the outer side of the belt layer 14 in the tire radial direction and that is made of organic fibers or steel cords coated with rubber. Also, the tire 10 may include a bead stiffener between the carcass layer 12 wound around the bead cores 16 and the bead filler rubbers 22.

The tire structure of the present disclosure is as described above. However, the tire structure is not particularly limited and a known tire structure is applicable.

In such a tire 10, when the breaking elongation of the carcass cord used in the carcass layer 12 is taken as Eb, the average thickness in a region R1 of the sidewall portion 10S between a tire maximum width position Pmax of the sidewall portion 10S in the tire radial direction and a position P1 separated from the tire maximum width position Pmax to the outer side in the tire radial direction by a length equivalent to 15% of a tire cross-section height is taken as Gs, and the average thickness in the tread portion 10T at a region R2 between a shoulder position P2 in which a straight line orthogonal to (a surface of) the carcass layer 12 passes through a maximum width belt layer of the belt layer 14, i.e., a maximum width position of the belt member 14a in the example illustrated in FIG. 1, and a shoulder position P3 separated from the shoulder position P2 to the inner side in the tire width direction by a length equivalent to 15% of a maximum belt width (length along the belt width direction) of the maximum width belt layer (the belt layer 14a) is taken as Gsh, Eb, Gs, and Gsh satisfy:

Eb≥20%;

Gsh≥10 mm;

Gs≥9 mm; and

60%≥Eb·Gsh/Gs≥18%.

The breaking elongation Eb complies with JIS-L1017 “Test methods for chemical fiber tire cords” and indicates an elongation rate (%) of a sample cord that is measured under the conditions that a length of specimen between grips is 250 mm and a tensile speed is 300±20 mm/minute. The “breaking elongation” indicates the value of the elongation rate that is measured when the cord breaks.

The type of organic fibers constituting the carcass cord having the breaking elongation Eb is not particularly limited, and for example, polyester fibers, nylon fibers, aramid fibers, or the like can be used. Out of these fibers, polyester fibers can be suitably used. Additionally, examples of the polyester fibers include polyethylene terephthalate fibers (PET fibers), polyethylene naphthalate fibers (PEN fibers), polybutylene terephthalate fibers (PBT), and polybutylene naphthalate fibers (PBN), and PET fibers can be suitably used.

Here, the tire cross-section height SH is a length along the tire radial direction from a position P4 of the innermost portion of the bead portion 10B in the tire radial direction to a tire outermost diameter position P5.

The thickness at each position for obtaining the average thickness Gs of the sidewall portion 10S and the average thickness Gsh in the tread portion 10T is the distance between the tire inner surface and the tire outer surface (the surface on the side where the tire 10 contacts the atmosphere) along a direction orthogonal to the carcass layer 12 (the innermost layer in the case of two or more layers). The average thicknesses are calculated by, for example, measuring the thickness per predetermined distance (e.g., every 1 mm).

By setting the breaking elongation Eb to 20% or more, the occurrence of shock bursts in which the carcass layer 12 breaks is suppressed even when the tire 10 is subjected to a large impact during traveling. The breaking elongation Eb is preferably 22% to 24% from the perspective of enhancing shock burst resistance.

However, when the breaking elongation Eb is increased, the rigidity of the carcass cord (tensile stress with respect to tensile elongation) is easily reduced. Therefore, the carcass cord extends and an easily deformable portion of the sidewall portion 10S or the shoulder region of the tread portion 10T deforms more significantly during run-flat traveling, and run-flat durability tends to decline.

Here, the shock burst resistance can be evaluated by indoor testing. For example, the shock burst resistance may be determined by a plunger breaking test. The plunger breaking test is a test for measuring the breaking energy generated when a tire breaks by pressing a plunger of a predetermined size into the center of the tread. Therefore, the breaking energy according to the plunger breaking test can be an indicator of the breaking energy (breaking durability against projection input of the tread portion 10T) when the tire 10 rides over protrusions on an uneven road surface.

On the other hand, run-flat durability is evaluated by, for example, a running distance until the tire 10 fails by run-flat traveling at a predetermined speed without filling the tire 10 with air pressure.

By setting the breaking elongation Eb to be 20% or more in this manner, shock burst resistance that has been a problem in the related art can be improved, but the run-flat durability is easily reduced and, therefore, the ranges of the average thicknesses Gs, Gsh of the tire 10 are defined in order to maintain or further improve the run-flat durability.

Furthermore, in order to improve the shock burst resistance as a result of setting the breaking elongation Eb at 20% or more, in the present disclosure, restrictions are provided to the average thicknesses Gsh, Gs in the tire 10 provided with the side reinforcing rubber layer 28.

That is, Gsh≥10 mm and Gsh≥9 mm, and 60%≥Eb·Gsh/Gs≥18%.

If the breaking elongation Eb is 20% or more but is near 20%, the improvement in the shock burst resistance is not great, so the average thickness Gsh is increased in order to improve the shock burst resistance.

The shock burst resistance is determined by the balance between the vertical spring characteristics of the sidewall portion 10S and the rigidity of the shoulder region of the tread portion 10T; the thinner the average thickness Gs, the smaller the vertical spring characteristics of the sidewall portion 10S, and the rigidity of the shoulder region becomes relatively larger, and the impact that the shoulder region of the tread portion 10T should absorb becomes smaller. As a result, a ratio of the average thickness Gs to the average thickness Gsh is preferably used as an indicator of the shock burst resistance. In this case, maintaining the average thickness Gs or increasing the average thickness Gsh and relatively increasing the rigidity of the shoulder region is preferable from the perspective of enhancing the shock burst resistance.

On the other hand, when the breaking elongation Eb is a numerical value that is relatively greater than 20%, the shock burst resistance is improved, but the rigidity of the carcass cord tends to be low. Consequently, the run-flat durability is easily reduced. The run-flat durability is also determined by the balance between the vertical spring characteristics of the sidewall portion 10S and the rigidity of the shoulder region of the tread portion 10T, and the greater the average thickness Gs, the greater the vertical spring characteristics of the tire 10. The rigidity of the shoulder region becomes relatively small, and vertical deformation of the sidewall portion 10S during run-flat traveling is reduced, and damage to the sidewall portion 10S during run-flat traveling is less likely to occur. Therefore, it is preferable to use the ratio between the average thickness Gs and the average thickness Gsh as an indicator of the run-flat durability. In this case, in order to improve the run-flat durability, it is preferable to maintain or reduce the average thickness Gsh or increase the average thickness Gs.

In addition, if Eb·Gsh/Gs is less than 18%, even if the breaking elongation Eb is far greater than 20%, the value of Gsh/Gs is small. Thus, the shock burst resistance becomes low. On the other hand, if Eb·Gsh/Gs exceeds 60%, even if the breaking elongation Eb is a value close to 20%, the run-flat durability becomes low because the value of Gsh/Gs is large. In the present disclosure, when the breaking elongation Eb is 20% or more, by setting Eb·Gsh/Gs at 18% or more and 60% or less, at least either one of the run-flat durability and the shock burst resistance can be maintained, while the other can be improved.

Furthermore, Eb·Gsh/Gs is preferably 20% or more and 40% or less, and more preferably 22% or more and 32% or less.

Furthermore, the upper limit of the average thickness Gsh is not limited as long as Eb·Gsh/Gs is 18% or more and 60% or less, but is preferably 28 mm, for example. Furthermore, the average thickness Gsh is preferably 13 mm to 23 mm.

In addition, the upper limit of the average thickness Gs is not limited as long as Eb·Gsh/Gs is 18% or more and 60% or less, but is preferably 28 mm. Furthermore, the average thickness Gs is more preferably 17 mm to 24 mm.

If the average thickness Gsh is less than 10 mm and the average thickness Gs is less than 9 mm, tire performance during not only run-flat traveling but also non-run-flat traveling is insufficient.

As illustrated in FIG. 1, each of the bead portions 10B of the tire 10 includes: the bead core 16 that extends in the tire circumferential direction to form an annular shape; and the bead filler rubber 22 extending from the bead core 16 toward the outer side in the tire radial direction. A length H along the tire radial direction from a position at the innermost portion of the bead portion 10B in the tire radial direction at the maximum height position of the bead filler rubber 22 is preferably 40 to 60% of the tire cross-section height SH. If the length H is less than 40% of the tire cross-section height SH, the shock burst resistance becomes improved, but the vertical spring characteristics of the tire 10 become low, the vertical deformation becomes significant, and the run-flat durability declines easily. If the length H exceeds 60% of the tire cross-section height SH, the vertical spring characteristics of the tire 10 increase, the vertical deformation becomes small, the impact on the shoulder regions of the tread portion 10T becomes large, and the shock burst resistance declines easily.

Note that the breaking elongation of the rubber of the side reinforcing rubber layer 28 (the breaking elongation (%) measured based on JIS (Japanese Industrial Standard) K6251 (using a dumbbell-shaped No. 3 test piece)) is preferably 120% or more, and preferably 130% or more, from the perspective of improving the run-flat durability.

At this time, as illustrated in FIG. 1, the thickness of the side reinforcing rubber layer 28 at a midpoint between an edge on the outer side of the bead filler rubber 22 in the tire radial direction along the carcass layer 12 and an end of the side reinforcing rubber layer 28 on the bead core 16 side (dimension along a normal line direction of the carcass layer 12 before being folded back by the bead core 16) is preferably 30 to 90% or more preferably 40 to 80% of the maximum thickness of the side reinforcing rubber layer 28.

According to one embodiment, the elongation at a load of 1.5 cN/dtex on the sidewall portion 10S of the carcass cord is preferably 5.0% or more. The elongation at the load of 1.5 cN/dtex (intermediate elongation) is preferably 5.0% to 6.5%. When the elongation at the load of 1.5 cN/dtex is less than 5.0% in a state where the breaking elongation Eb is 20% or more, a compressive strain of the end of the carcass cord wrapped around the bead cores 16 increases, leading to breakage of the carcass cord, and consequently the run-flat durability declines. Note that, as with the breaking elongation Eb, the elongation at the load of 1.5 cN/dtex is an elongation ratio (%) of a sample cord, which is measured by conducting a tensile test in accordance with JIS-L1017 “Test methods for chemical fiber tire cords” and under the conditions that a length of specimen between grips is 250 mm and a tensile speed is 300±20 mm/minute.

Additionally, the fineness based on corrected mass (JIS L1017: 2002) after dip processing of the carcass cord is preferably 4000 to 8000 dtex. By setting the fineness based on corrected mass at 4000 to 8000 dtex, elongation at the load of 1.5 cN/dtex can be reduced while the breaking elongation Eb of the carcass cord is maintained at 20% or more, and the run-flat durability can be improved while keeping the improved shock burst resistance.

According to one embodiment, the twist coefficient K indicated by the following equation after dip processing of the carcass cord is preferably 2000 to 2500:

K=T×D^{1/2}

T: Upper twist count of carcass cord (times/10 cm);

D: Total fineness of carcass cord (dtex).

Setting the twist coefficient K at 2000 to 2500 makes it possible to improve high-speed durability. If the twist coefficient K is less than 2000, repeated compression deformation of the portion of the carcass layer 12 folded back around the bead cores 16 that is caused by the collapsing of the bead portions 10B when the tire rolls may cause fatigue to occur in the carcass layer 12, and there is a risk that improvement in high-speed durability cannot be sufficiently obtained.

### Example, Comparative Example

To confirm the effect of the tire 10, tires were manufactured in which the material of the carcass layer 12 and the thickness and width of the side reinforcing rubber layer 28 of the tire 10 were varied, the value of Eb·Gsh/Gs was adjusted, and the shock burst resistance and the run-flat durability were evaluated by indoor testing.

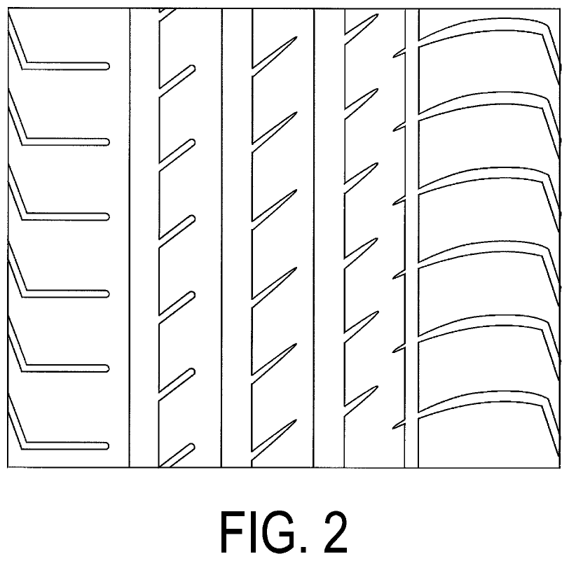

The tires manufactured each have a tire size of 265/35RF20, have the basic structure illustrated in FIG. 1, and have a tread pattern illustrated in FIG. 2 in the tread portion 10T. FIG. 2 is a diagram illustrating the tread pattern of the tires manufactured in the experiment examples. The tread pattern has four circumferential main grooves, and a lug groove is provided in the region of the three land portions sandwiched by the four circumferential main grooves.

The tires manufactured were assembled on a wheel having a rim size of 20×9.5 J.

Evaluation of the shock burst resistance was performed by the plunger breaking test. The plunger breaking test was performed in accordance with JIS K6302 by filling each tire assembled on the rim with an air pressure of 220 kPa, with a plunger diameter of 19 mm and an insertion speed of 50 mm/minute, to measure the tire breakage energy.

The tire breaking energy of each tire is expressed as an index, with the tire breaking energy of Comparative Example 1 shown in Table 1 as the reference (index 100). Larger indexes indicate higher tire breaking energy and superior shock burst resistance.

Evaluation of the run-flat durability was performed by rolling each tire assembled to the rim on an indoor drum in an environment with a maximum load capacity×0.65, a speed of 80 km/hr, and a temperature of 38° C. without filling each tire with internal pressure, and the running distance until each tire failed was measured. The traveling distance was expressed as an index, with the distance traveled until the tire of Comparative Example 1 shown in the following table failed as the reference (index 100). Larger indexes indicate longer travel distances to failure and superior run-flat durability.

The maximum load capacity refers to a “maximum load capacity” defined by JATMA with which the tires comply, the maximum value in “TIRE LOAD LIMITS AT VARIOUS COLD INFLATION PRESSURES” defined by TRA, or “LOAD CAPACITY” defined by ETRTO.

In Comparative Examples 1 to 3 and Examples 1 to 8 shown in Tables 1, 2 below, the average thickness Gsh was set at 10 mm or more, the average thickness Gs at 9 mm or more, and the breaking elongation Eb of the carcass cord at 20% or more.

“H/SH” shown in Tables 1, 2 below indicates the ratio of the length H of the bead filler rubber 22 illustrated in FIG. 1 to the tire cross-section height SH, and “carcass cord intermediate elongation” indicates elongation at a load of 1.5 cN/dtex.

TABLE 1

| | Comparative | Comparative | | Comparative |
|---|---|---|---|---|
| | Example 1 | Example 2 | | Example 3 |
| Eb•Gsh/GS (%) | 8 | 15 | | 65 |
| H/SH (%) | 45 | 45 | | 45 |
| Carcass cord | 6 | 6 | | 6 |
| intermediate | | | | |
| elongation (%) | | | | |
| Fineness based on | 3500 | 3500 | | 3500 |
| corrected mass (dtex) | | | | |
| Twist coefficient K | 1500 | 1500 | | 1500 |
| Shock burst | 100 | 95 | | 100 |
| resistance | | | | |
| Run-flat durability | 100 | 100 | | 95 |
| | Example 1 | Example 2 | Example 3 | Example 4 |
| Eb•Gsh/GS (%) | 18 | 30 | 55 | 60 |
| H/SH (%) | 45 | 45 | 45 | 45 |
| Carcass cord | 6 | 6 | 6 | 6 |
| intermediate | | | | |
| elongation (%) | | | | |
| Fineness based on | 3500 | 3500 | 3500 | 3500 |
| corrected mass (dtex) | | | | |
| Twist coefficient K | 1500 | 1500 | 1500 | 1500 |
| Shock burst | 100 | 102 | 104 | 102 |
| resistance | | | | |
| Run-flat durability | 102 | 104 | 102 | 100 |

TABLE 2

| | Example 5 | Example 6 | Example 7 | Example 8 |
|---|---|---|---|---|
| Eb•Gsh/GS (%) | 30 | 30 | 30 | 30 |
| H/SH (%) | 35 | 65 | 45 | 45 |
| Carcass cord intermediate | 6 | 6 | 4 | 6 |
| elongation (%) | | | | |
| Fineness based on | 3500 | 3500 | 3500 | 5500 |
| corrected mass (dtex) | | | | |
| Twist coefficient K | 1500 | 1500 | 1500 | 1500 |
| Shock burst resistance | 104 | 102 | 102 | 102 |
| Run-flat durability | 100 | 102 | 100 | 105 |

From Examples 1 to 4 and Comparative Examples 1 to 3 in Table 1 above, by setting Eb·Gsh/Gs at 18% to 60%, either one of the shock burst resistance and the run-flat durability can be maintained while improving the other.

From Tables 1, 2 above, it can be seen that Example 2, in which the ratio of the length H of the bead filler rubber 22 to the tire cross-section height SH was 40% or more, improved the shock burst resistance compared to Comparative Examples 1 to 3, and improved the run-flat durability compared to Example 5 in which the ratio of the length H to the tire cross-section height SH was less than 40%. Furthermore, it can be seen that Example 6, in which the ratio was greater than 60%, reduced the shock burst resistance compared to Example 5.

From Tables 1, 2 above, it can be seen that Example 2, in which the intermediate elongation (elongation at a load of 1.5 cN/dtex) was 5% or more, improved the run-flat durability compared to Example 7 in which the intermediate elongation was less than 5%.

It can be seen from Tables 1, 2 above that Example 8, in which the fineness based on corrected mass was within the range of 4000 to 8000 dtex, improved the run-flat durability while maintaining the shock burst resistance, compared to Example 2 in which the fineness based on corrected mass was outside the range of 4000 to 8000 dtex.

The above has described the tire of the present disclosure in detail. However, the present disclosure is not limited to the above embodiments and Examples, and may be improved or modified in various ways without departing from the gist of the present technology.

1-8. (canceled)

9. A tire, comprising:
a tread portion extending in a tire circumferential direction and having an annular shape;
a pair of sidewall portions comprising side rubbers disposed on both sides of the tread portion;
a pair of bead portions disposed on an inner side of the sidewall portions in a tire radial direction;
at least one carcass layer mounted between the pair of bead portions;
a side rubber reinforcing layer that extends in the tire radial direction along an inner surface on an inner surface side of the carcass layer of the sidewall portions and that reinforces the side rubbers; and
a plurality of belt layers arranged on an outer side of the carcass layer in the tread portion in the tire radial direction,
the carcass layer being composed of a carcass cord formed of organic fiber cords formed by twisting together a filament bundle of organic fibers, and
when:
a breaking elongation of the carcass cord is taken as Eb,
an average thickness of the sidewall portions between a tire maximum width position of the sidewall portions in the tire radial direction and a position separated from the tire maximum width position to the outer side in the tire radial direction by a length equivalent to 15% of a tire cross-section height is taken as Gs, and
an average thickness in the tread portion between a shoulder position where a straight line orthogonal to the carcass layer and passing through a maximum width position of a maximum width belt layer of the belt layer intersects a surface of the tread portion, and a position separated from the shoulder position toward an inner side in a tire width direction by a length equivalent to 15% of a maximum belt width of the maximum width belt layer is taken as Gsh,
Eb, Gs, and Gsh satisfying the following:
(1) Eb≥20%;
(2) Gsh≥10 mm;
(3) Gs≥9 mm; and
(4) 60%≥Eb·Gsh/Gs≥18%.

10. The tire according to claim 9, wherein the bead portions each comprise a bead core extending in an annular shape in the tire circumferential direction, and a bead filler rubber extending from the bead core toward the outer side in the tire radial direction, and
a length of a maximum height position of the bead filler rubber along the tire radial direction from a position at an innermost portion of the bead portion in the tire radial direction is 40 to 60% of the tire cross-section height.

11. The tire according to claim 9, wherein an elongation of the carcass cord when subjected to a load of 1.5 cN/dtex in the sidewall portions is 5.0% or more.

12. The tire according to claim 9, wherein an elongation of the carcass cord when subjected to a load of 1.5 cN/dtex in the sidewall portions is 5.0% to 6.5%.

13. The tire according to claim 9, wherein the breaking elongation Eb of the carcass cord is 22% to 24%.

14. The tire according to claim 9, wherein the organic fibers constituting the carcass cord are polyethylene terephthalate fibers.

15. The tire according to claim 9, wherein a fineness based on corrected mass after dip processing of the carcass cord is 4000 to 8000 dtex.

16. The tire according to claim 9, wherein a twist coefficient K expressed by the following equation after dip processing of the carcass cord is 2000 to 2500:
K=T×D^{1/2},
(where T is an upper twist count (times/10 cm) of the carcass cord and D is a total fineness (dtex) of the carcass cord).

17. The tire according to claim 10, wherein an elongation of the carcass cord when subjected to a load of 1.5 cN/dtex in the sidewall portions is 5.0% or more.

18. The tire according to claim 17, wherein an elongation of the carcass cord when subjected to a load of 1.5 cN/dtex in the sidewall portions is 5.0% to 6.5%.

19. The tire according to claim 18, wherein the breaking elongation Eb of the carcass cord is 22% to 24%.

20. The tire according to claim 19, wherein the organic fibers constituting the carcass cord are polyethylene terephthalate fibers.

21. The tire according to claim 20, wherein a fineness based on corrected mass after dip processing of the carcass cord is 4000 to 8000 dtex.

22. The tire according to claim 21, wherein a twist coefficient K expressed by the following equation after dip processing of the carcass cord is 2000 to 2500:
K=T×D^{1/2},
(where T is an upper twist count (times/10 cm) of the carcass cord and D is a total fineness (dtex) of the carcass cord).
